(19) United States
(12) Patent Application Publication
(10) Pub. No.: US 2010/0009826 A1
(43) Pub. Date: Jan. 14, 2010

(54) Device for Indicating the Amount of Paper Used or the Amount of Paper Remaining on a Roll of Paper

(76) Inventors: Vecheslav Basin, Ashdod (IL); Uzi Ezra Havosha, Tel Aviv (IL)

Correspondence Address: UZI EZRA HAVOSHA & PARTNERS, HADAR-DAFNA HOUSE 39 SHAOUL HAMELECH STREET, TEL AVIV, 64928, IL

(21) Appl. No.: 12/172,281

(22) Filed: Jul. 14, 2008

(51) Int. Cl. B05C 11/00

(52) U.S. Cl. 492/10

(57) ABSTRACT

Visual or vocal signals indicating the amount of paper used or the amount of paper remaining on a roll of paper. A roll of paper including stickers or numerals stuck, printed 20 or embossed onto the paper at different positions in the roll where the stickers or numeral differing one from another depending on the position of the sticker in the roll.

### FIELD OF THE INVENTION

This invention is in the field of paper and more specifically where paper is rolled into a roll and is used by pulling lengths of paper off the roll, the amount of paper used or the amount of paper remaining on the roll is indicated visually and/or vocally.

### BACKGROUND OF THE INVENTION

Where paper is rolled into a roll and is used by pulling lengths of paper off the roll it would be useful for there to be a visual and/or audible reminder the paper roll has reached different stages of advancement towards the end of the roll 15 when the roll will need replacing.

This invention applies to any kind of paper or paper-like material that is rolled into a roll and used by pulling lengths off the roll. This specification refers to the application to a typical such use, namely, the toilet paper roll. 20

### SUMMARY OF THE INVENTION

It is to be understood that both the foregoing general description and the following detailed description present embodiments of the invention and are intended to provide an overview or framework for understanding the nature and character of the invention as it is claimed.

The present invention reveals a way for indicating the amount of paper used or the amount of paper remaining on a roll of paper.

A roll of paper including stickers stuck onto the paper at different positions in the roll and the stickers differing one from another depending on the position of the sticker in the roll.

Alternatively, there could be numerals on the paper at different positions in the roll the numerals differing depending on the position of the numeral in the roll.

A further option is for a clip of sensors that attach to a roll of paper including a rod of a length being substantially the diameter of the roll when complete with paper, sensors attached to the rod spaced at intervals on the rod, an attaching means to removably attach the rod to a central portion in the roll. There could also be lights attached to the rod spaced at intervals on the rod and connected electronically to the sensors and a vocal means attached to the rod and connected electronically to the sensors. There would be an energy source to which is attached the sensors, the lights and the vocal means.

The roll of paper of this invention could refer to any kind of roll of paper but the preferred embodiment is the toilet roll used for personal hygiene.

The stickers could be colored and their differing color would indicate their position in the roll. For example the differing color could be fading shades of the same basic color whereby the color of the stickers could weaken or strengthen as the paper is used.

Another option could be to use numerals printed or embossed on the paper to indicate the number of sheets of paper left on the roll.

Another option could be for the stickers to have an electronic chip that could be initialized by pulling off a film of material where one side of the material is stuck to the sticker and the reverse side of the material is stuck to the paper of the roll. The sticking of the material to the sticker is a weaker sticking strength than the sticking of the reverse side of the material to the paper. The effect of this different degree of sticking is that when the layer of paper above the sticker is pulled off the roll the material will stay stuck to the paper being pulled of and will separate from the upper surface of the sticker. This action would activate the vocal or other electronic features of the sticker that indicate to the user how much paper remains on the roll.

Any of the above signals indicating the amount of paper used or the amount of paper remaining on a roll of paper might also be used as advertisement for any company or other product.

### BRIEF DESCRIPTION OF THE DRAWINGS

The accompanying drawings are included to provide a further understanding of the invention and are incorporated into and constitute a part of this specification. The drawings illustrate various embodiments of the invention and, together with the description, serve to explain the principles and operations of the invention, by way of example only and not to limit the invention to these descriptions only.

FIG. 1 is a schematic diagram of a roll of paper with stickers stuck onto the paper.

FIG. 2 is a schematic diagram of a roll of paper with stickers that include electronic chip with a vocal indication.

FIG. 3 is a schematic diagram of a cross sectional of a sticker that includes electronic chip with a vocal indication.

FIG. 4 is a schematic diagram of a clip of sensors attached to a roll of paper.

### DETAILED DESCRIPTION OF THE PREFERRED EMBODIMENTS

As will be appreciated the present invention is capable of other and different embodiments than those discussed above and described in more detail below, and its several details are capable of modifications in various aspects, all without departing from the spirit of the invention.

Accordingly, the drawings and description of the embodiments set forth below are to be regarded as illustrative in nature and not restrictive.

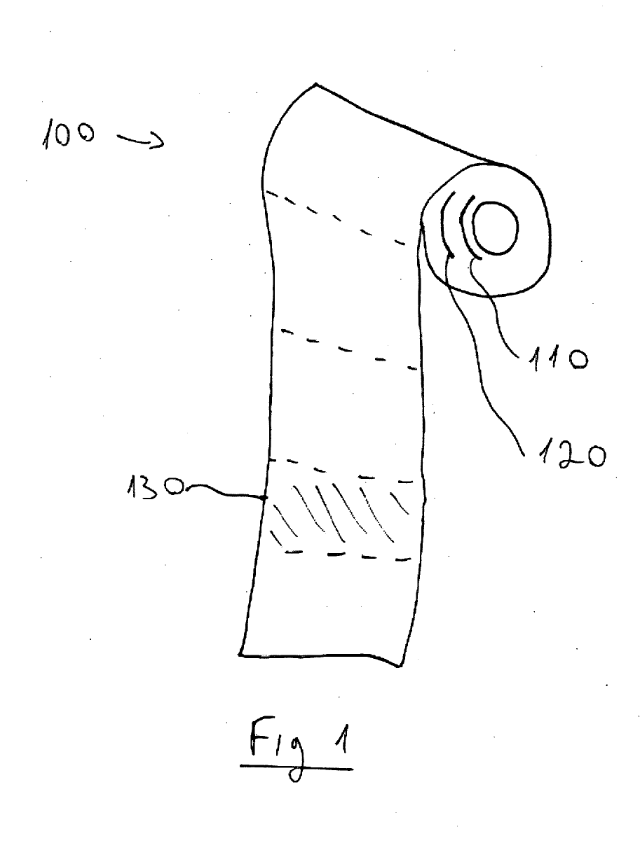

FIG. 1 shows a roll of paper 100 with stickers stuck onto the paper. The sticker would be stuck onto the paper at different positions 110 and 120 in the roll. The stickers would be differing one from another depending on and indicating the position of the sticker in the roll. The difference of the stickers might be by way of color, the stickers could be colored and their differing color would indicate their position in the roll. For example the color of the stickers could weaken or strengthen as the paper is used, if for example the first sticker 130 is colored with a light red or even pink, the second sticker on the roll 120 would be colored with a darker red, and the last sticker on the roll 110, indicating the end of the roll, would be colored with a very dark red.

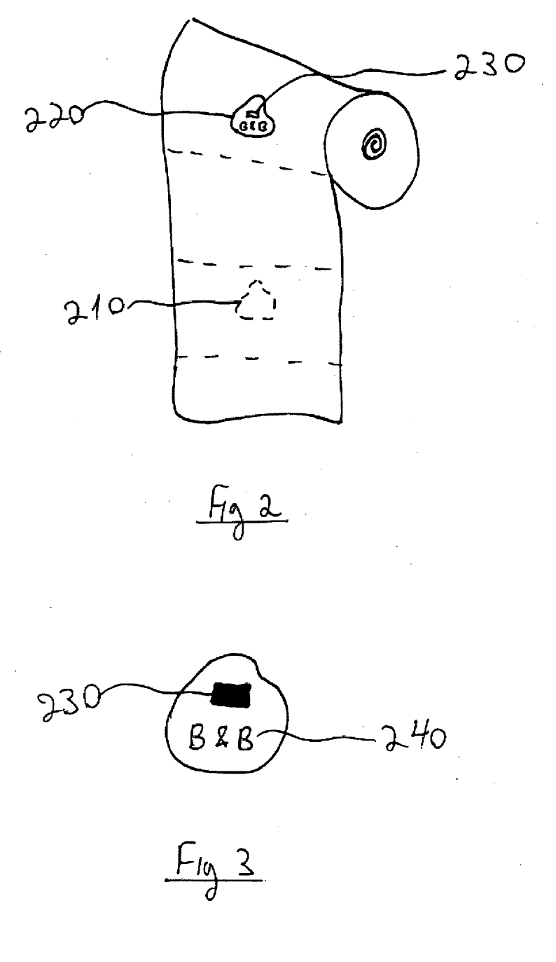

FIG. 2 shows a roll of paper with stickers that include a vocal signal indicating the amount of paper used or the amount of paper remaining on a roll of paper. The sticker is made of two layers, upper portion 210 and lower portion 220, and an electronic chip 230 placed between both layers. Both portion would be stuck to each other by small amount of glue and would stuck to the roll of paper bigger amount of glue so when a user pull the roll of paper at the place were the sticker is located the upper portion of the sticker 210 would separated from the lower portion 220 and activating the electronic chip 230 that place between them.

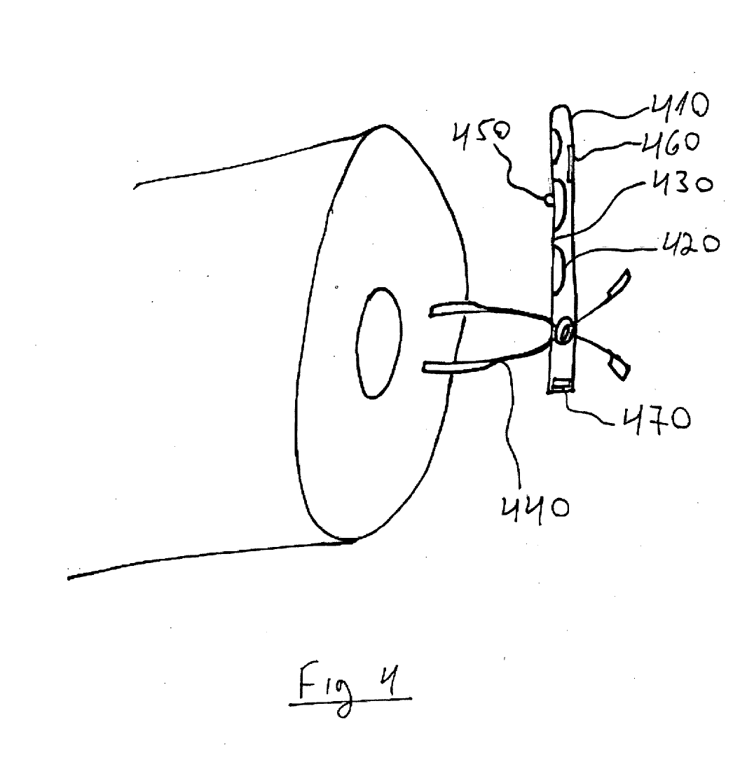

FIG. 3 shows a cross sectional view of a sticker that includes an electronic chip with a vocal indication of the amount of paper used or left. The electronic chip 230 is placed between two portions of the sticker that are separated when the roll of paper is pulled and by that causing an electrical circuit to be closed that further activating the electronic chip 310. The electronic chip includes a source of energy, as a mall battery, enabling the electrical circuit and an audio massage recorded and store on the electronic chip that is heard when the chip is activated. The sticker might also include an advertisement massage that can be head on the audio massage or can be seen visually if printed on the stickers 240 for example.

FIG. 4 shows a clip of sensors attached to a roll of paper. The clip of sensors that is attached to a roll of paper including a rod of a length 410 being substantially the diameter of the roll when complete with paper, sensors 420 attached to the rod spaced at intervals 430 on the rod, and an attaching means 440 to removably attach the rod to a central portion in the roll. There could also be lights 450 attached to the rod spaced at intervals on the rod and connected electronically to the sensors and a vocal means 460 attached to the rod and connected electronically to the sensors. There would be an energy source 470 as battery to which the sensors, the lights and the vocal means would be connected.

What is claimed:

1. A roll of paper with at least one sticker stuck onto said paper at a specific location in said roll indicating the amount of paper used or the amount of paper remaining on said roll of paper. Said sticker comprising
a. a lower portion attached to said paper roll,
b. an upper portion attached to said lower portion by small amount of glue, on one side, and to said roll of paper by bigger amount of glue, on the other side of the upper portion of the sticker,
c. an electronic chip placed between said lower and upper portions. Said electronic chip is activated when said upper portion is separated from lower portion when a user pull said paper roll at the place were said sticker is located and by that cause to a closing of an electrical circuit,
d. a source of energy, as battery, enabling said electrical circuit,
e. an audio massage recorded and store on said electronic chip said audio is heard when said electronic chip is activated.

2. A roll of paper as claimed in claims 1 wherein said roll of paper is a toilet roll used for personal hygiene.

3. A roll of paper as claimed in claims 1 wherein said audio massage in 1.e. contains at least one of the following:
a. a single tone to be used as an alert of the amount of paper used or remained on said paper roll.
b. a single word indicating the amount of paper used or remained on said paper roll.
c. a short sentence indicating the amount of paper used or remained on said paper roll.
d. a commercial massage.

4. A roll of paper as claimed in claims 1 further includes at least two stickers. Said stickers stuck onto said paper at different locations in said roll, indicating different amount of paper used or different amount of paper remaining on said roll of paper.

5. A roll of paper as claimed in claim 4 wherein said stickers are differing one from another depending on the location of said stickers on said roll. Said differing is by difference in said audio massage.

6. A roll of paper with signs indicating the amount of paper used or the amount of paper remaining on said roll of paper. Said roll of paper comprising,
a. a roll of paper
b. at least two sings placed on different locations on said roll of paper,
c. said sings are differing one from another depending on the position of the said sign in said roll.

7. A roll of paper as claimed in claims 6 wherein said roll of paper is a toilet roll used for personal hygiene.

8. A roll of paper as claimed in claims 6 wherein said sings are at least one of the following
a. Colored stickers stuck on said roll of paper, wherein said differing of said stickers is by way of color.
b. Stickers stuck on said roll of paper, said sticker include printed advertisements.
c. Numerals printed or embossed on said loll of paper.

9. A clip of sensors that attach to a roll of paper indicating the amount of paper used or the amount of paper remaining on said roll said clip of sensors comprising,
a. a rod of a length being substantially the diameter of said roll when complete with paper,
b. sensors attached to said rod spaced at intervals on said rod,
c. an attaching means to removably attach the said rod to a central portion in said roll,
d. lights attached to said rod spaced at intervals on said rod connected electronically to said sensors,
e. a vocal means attached to the said rod connected electronically to said sensors,
f. an energy source attached to said sensors, said lights and said vocal means.
